(19) United States
(12) Patent Application Publication
(10) Pub. No.: US 2024/0150152 A1
(43) Pub. Date: May 9, 2024

(54) ELEVATOR GROUP CONTROL DEVICE

(71) Applicant: Mitsubishi Electric Corporation, Tokyo (JP)

(72) Inventor: Kazunori SAKO, Aichi (JP)

(73) Assignee: Mitsubishi Electric Corporation, Tokyo (JP)

(21) Appl. No.: 18/282,225

(22) PCT Filed: Mar. 24, 2021
(86) PCT No.: PCT/JP2021/012099

§ 371 Date: Sep. 15, 2023

(51) Int. Cl. B66B 1/46; B66B 1/24; B66B 1/34

(52) U.S. Cl. CPC B66B 1/468; B66B 1/2408; B66B 1/3423; B66B 2201/211; B66B 2201/214; B66B 2201/215; B66B 2201/22; B66B 2201/222; B66B 2201/223

(57) ABSTRACT

A group control device according to the present disclosure includes a registration unit, a calculation unit, and a selection unit. The registration unit makes call registration for a boarding floor, a destination floor, and an allocated car when a user makes a hall destination call by a hall destination calling device. The calculation unit calculates an in-car stay time of the user for the hall destination call. The selection unit selects a past hall destination call as an alternative candidate for call registration for a new hall destination call, in a case where the past hall destination call which has already been registered by the registration unit, whose allocated car is different from a car allocated to the new hall destination call, and whose in-car stay time is shorter than the in-car stay time calculated by the calculation unit.

### TECHNICAL FIELD

The present disclosure relates to a group control device for an elevator.

### BACKGROUND ART

Some group control devices for an elevator with a plurality of cars employ a hall destination calling method in which elevator users reserve their destination floors before boarding the cars. In such group control devices that employ the hall destination call, the destinations are registered at the halls before the users board the cars; thus, it is possible to improve the transportation efficiency of users on the basis of the destination floor information, for example, by allocating cars so that users with the same destination floor board the same car.

The group control device described in Patent Document 1 simulates the operation of a plurality of cars on the basis of information indicating the operation status of the elevator, and thereby calculates, when a hall destination call is made at each floor, the waiting time until a car arrives at the hall. When the user actually makes the hall destination call, the display of each floor that is a candidate for the user's destination floor is changed on the basis of the calculated waiting time. This allows the user to determine the destination floor taking into account the waiting time until the car arrives at the hall.

### PRIOR ART DOCUMENT

### Patent Document

Patent Document 1; Japanese Unexamined Patent Application Publication No. 2017-178564

### SUMMARY OF INVENTION

### Problems to be Solved by Invention

The above group control device is not equipped with a means to calculate an in-car stay time of a user when the user boards a car and moves to the destination floor. Therefore, there has been a problem that a car having a short in-car stay time cannot be allocated to a hall destination call.

The present disclosure has been made in view of the above problem, and an object thereof is to provide an elevator group control device capable of allocating a car having a short in-car stay time to a hall destination call.

### Means for Solving Problems

An elevator group control device according to the present disclosure comprises: a registration unit to make call registration for a boarding floor, a destination floor, and an allocated car when a user makes a hall destination call by a hall destination calling device; a calculation unit to calculate an in-car stay time of the user for the hall destination call; and a selection unit to select a past hall destination call as an alternative candidate for call registration for a new hall destination call which is a hall destination call newly made by the user, in a case where the past hall destination call is a hall destination call which has already been registered by the registration unit, whose allocated car is different from a car allocated to the new hall destination call, and whose in-car stay time is shorter than the in-car stay time calculated by the calculation unit.

### Effects of Invention

According to the present disclosure, it is possible to provide an elevator group control device capable of allocating a car having a short in-car stay time to a hall destination call.

### BRIEF DESCRIPTION OF DRAWINGS

FIG. 1 is a configuration diagram showing an elevator unit including a group control device according to Embodiment 1.

FIG. 2 is a front view showing a hall operation indicator according to Embodiment 1.

FIG. 3 is a flowchart showing control of the group control device according to Embodiment 1.

FIG. 4 is a diagram showing information of a call registration information file according to Embodiment 1.

FIG. 5 is a configuration diagram showing an elevator system including a group control device according to Embodiment 2.

FIG. 6 is a diagram showing information of a user information file according to Embodiment 2.

FIG. 7 is a flowchart showing control of the group control device according to Embodiment 2.

FIG. 8 is a front view showing a mobile terminal according to Embodiment 2.

FIG. 9 is a diagram showing information of a call registration information file according to Embodiment 3.

FIG. 10 is a flowchart showing control of a group control device when outputting call registration options according to Embodiment 3.

FIG. 11 is a flowchart showing control of the group control device when receiving the call registration options according to Embodiment 3.

FIG. 12 is a diagram showing information of a user information file according to Embodiment 4.

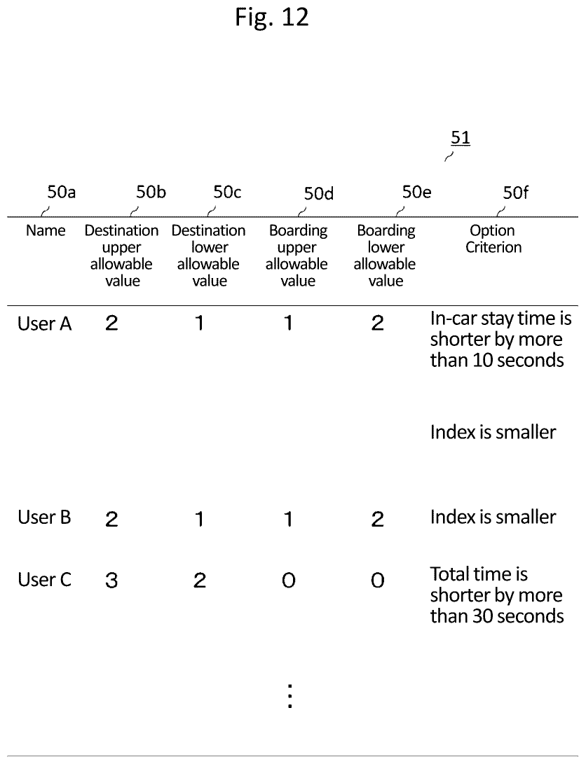

### MODE FOR CARRYING OUT INVENTION

### Embodiment 1

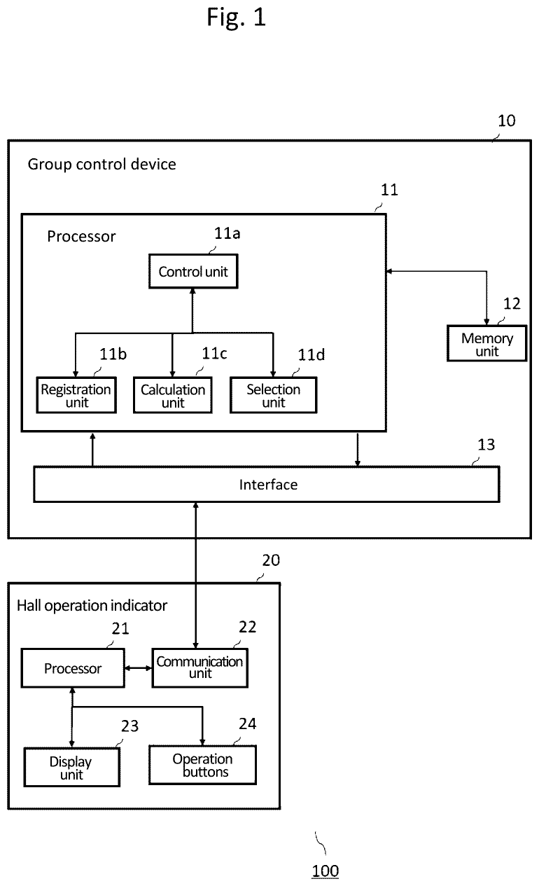

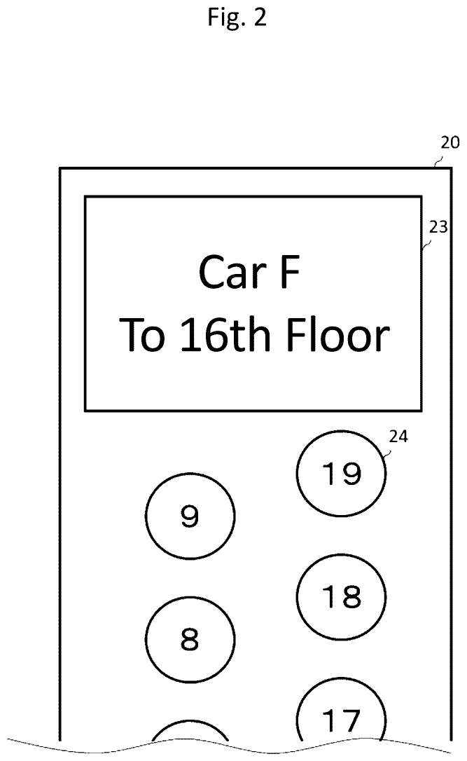

An elevator unit 100 provided with a group control device 10 according to Embodiment 1 will be described below with reference to the drawings. Note that the same reference numerals in the drawings denote the same or equivalent configurations and steps. FIG. 1 is a configuration diagram of the elevator unit 100 according to Embodiment 1. First, the configuration of the elevator unit 100 will be described using FIG. 1 and FIG. 2.

The elevator unit 100 includes the group control device 10, a hall operation indicator 20 installed at each elevator hall, and a plurality of cars and car drive units (not shown). In the elevator unit 100 according to the present embodiment, the group control device 10 outputs a command for moving a car to a car drive unit (not shown) on the basis of a hall destination call made by a user using the hall operation indicator 20.

FIG. 2 is a front view of the hall operation indicator 20, which is a hall destination calling device by which a user makes a hall destination call. When the user presses an operation button 24, information on the floor where the hall operation indicator 20 is installed and the destination floor corresponding to the operation button 24 pressed by the user is transmitted to the group control device 10. Then, the group control device 10 allocates a car on the basis of the received information on the hall destination call information and makes call registration. The call registration is to store a destination floor, a boarding floor, and an allocated car in a call registration information file 40, which will be described later.

Here, general car allocation based on hall destination call information will be described. Regardless of whether a hall destination call will be adopted or not, when a user calls a car from a hall, the group control device 10 calculates an evaluation value for each car and allocates a car with a high evaluation value to the call. When calculating the evaluation value, in addition to evaluating the time until the car arrives at the hall, an adjustment is made; for example, if the hall where a user makes a hall call is in the direction of a moving car, an addition is made to the evaluation value of the moving car. In particular, in a group control device employing a hall destination call, an evaluation value is adjusted on the basis of a destination floor designated by a user at a hall. For example, for a car allocated to a call whose destination floor is the same as the destination floor pressed by the user at the hall, an adjustment such as further addition to the evaluation value is made.

While the evaluation value is calculated as described above, if the evaluation value is adjusted so that the in-car stay time of the user is further shortened, there is a possibility that the transportation efficiency of the user decreases.

In the present embodiment, therefore, when a new hall destination call, which is a newly made hall destination call, is made by a user, the in-car stay time of the user is calculated on the assumption that, the group control device 10 calculates the evaluation values for the hall destination call and allocates a car. Then, from among the past hall destination calls, which are hall destination calls in the past and whose call registrations have already been performed, a hall destination call whose in-car stay time is shorter than that of the new hall destination call is selected as an alternative candidate. The user then rides with another user who made a hall destination call for the alternative candidate, and gets off at a floor close to the desired destination floor. In this way, a car with a short in-car stay time can be allocated while preventing a decrease in transportation efficiency due to the registration of a new hall destination call. In addition, the short in-car stay time improves user comfort and public health such as infection control.

Next, the configurations of the group control device 10 and the hall operation indicator 20 will be described in more detail with reference to FIG. 1.

The group control device 10 includes a processor 11, a memory unit 12, and an interface 13.

The processor 11 is a central processing unit (CPU), and is connected to the memory unit 12 and the interface 13 to exchange information. The processor 11 includes a control unit 11a, a registration unit 11b, a calculation unit 11c, and a selection unit 11d.

The control unit 11a includes a software module for controlling the registration unit 11b, the calculation unit 11c, and the selection unit 11d, and for controlling the entire elevator unit 100 including a plurality of cars and car drive units (not shown). The control unit 11a includes a software module that outputs a command to display, on a display unit 23 to be described later, a car and a destination floor allocated to a new hall destination call.

The registration unit 11b includes a software module that makes, when a user makes a hall destination call using the hall operation indicator 20, call registration for a boarding floor, a destination floor, and an allocated car in a call registration information file 40 stored in the memory unit 12, which will be described later.

The calculation unit 11c includes a software module for calculating the in-car stay time of a user for a new or past hall destination call. The calculation unit 11c also includes a software module for calculating an evaluation value to be used for car allocation.

The selection unit 11d includes a software module that selects a past hall destination call, which is a hall destination call that has already registered, as an alternative candidate for a new hall destination call which is a hall destination call newly made by a user, if the in-car stay time of the past hall destination call is shorter than the in-car stay time of the new hall destination call. The software module selects the alternative candidate from past hall destination calls whose destination floors and boarding floors within predetermined ranges are registered. In the present embodiment, a boarding floor is a floor where the hall operation indicator 20 is installed and a new hall destination call is made. A destination floor is a floor designated by the new hall destination call, and “within predetermined ranges” means ranges in which the boarding floors are identical and the destination floors are a floor designated by a hall destination call and one floor above and below that floor.

The memory unit 12 is a memory device that stores the call registration information file 40 which will be described later. The memory unit 12 stores information used for the processing of the processor 11, and stores information generated by the processing of the processor 11.

The interface 13 includes terminals for connecting the hall operation indicator 20 and an electrical wire (not shown). The interface 13 includes terminals for connecting other components necessary for operating the elevator unit 100, such as the cars and the car drive units (not shown). The interface 13 may be connected to other components by wireless communication as a wireless communication device.

The hall operation indicator 20 includes a processor 21, a communication unit 22, the display unit 23, and operation buttons 24. The processor 21 is a CPU that is a control device of the hall operation indicator 20, and is connected to the communication unit 22, the display unit 23, and the operation buttons 24 to exchange information. The communication unit 22 is a terminal that performs wired communication with the interface 13 of the group control device 10 via the electrical wire.

As shown in FIG. 2, when a user makes a hall destination call, the display unit 23 displays the car (Car F in FIG. 2) and the destination floor (16th floor in FIG. 2) which are allocated to the hall destination call. As shown in FIG. 2, the operation buttons 24 are push buttons corresponding to their respective floors and are pressed by the user. The destination floor displayed on the display unit 23 does not necessarily correspond to the operation button 24 pressed by the user. That is, when an alternative candidate for a new hall destination call is selected by the selection unit 11d, the destination floor of the past hall destination call that is the alternative candidate is displayed, and the user who made the new hall destination call is encouraged to get off at the displayed floor.

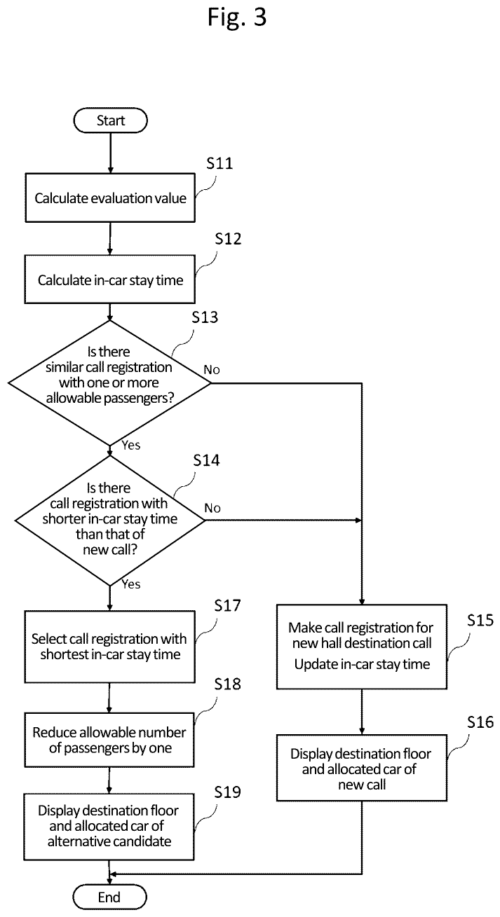

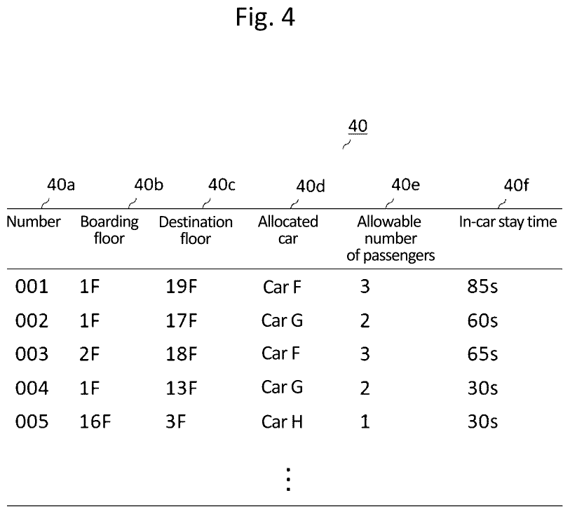

Next, the operation of the present embodiment will be described using FIG. 3 and FIG. 4. FIG. 3 is a flowchart showing control of the group control device 10 when a new hall destination call is made by a user.

The control unit 11a starts the processing shown in FIG. 3 when a new hall destination call is made by the user. Specifically, when an operation button 24 of the hall operation indicator 20 is pressed by the user, the hall operation indicator 20 transmits information on the floor where the hall operation indicator 20 is installed and information on the floor corresponding to the pressed operation button 24 as call information via the communication unit 22. Then, the control unit 11a starts the processing when it receives the call information via the interface 13. In the present embodiment, the floor where the hall operation indicator 20 is installed is the boarding floor of the user who made the new hall destination call, and the floor corresponding to the pressed operation button 24 is the destination floor desired by the user.

In step S11, the calculation unit 11c calculates an evaluation value for the new hall destination call, and advances the processing to step S12. Specifically, the calculation unit 11c calculates evaluation values for a plurality of cars provided in the elevator unit 100 from the call information, information on the past hall destination calls stored in the call registration information file 40, the current car position, and the like, as in a conventional group control device that employs hall destination calls.

FIG. 4 is a diagram showing an example of the call registration information file 40. The call registration information file 40 is a data file in which call registration information is stored by the registration unit 11b through the processing of step S15, which will be explained later. The control unit 11a performs group control of the elevator unit 100 by outputting commands to the car drive units according to the call registration information stored in the call registration information file 40.

The call registration information file 40 includes registration number information 40a which is a serial number, boarding floor information 40b, destination floor information 40c, allocated car information 40d, allowable-number-of-passengers information 40e, and in-car stay time information 40f. The boarding floor information 40b is information that indicates the floor where the user boards a car and where, in the present embodiment, the hall operation indicator 20 that transmitted the call information is installed. The destination floor information 40c is information indicating the floor at which the car that has moved according to the call registration information stops. The allocated car information 40d is information indicating a car allocated to each call registration. In the following description, it is assumed that the elevator unit 100 according to the present embodiment is provided with three cars, i.e. Car F, Car G, and Car H. The allowable-number-of-passengers information 40e is information indicating how many additional passengers can ride in the car allocated to each call registration. The in-car stay time information 40f is information indicating the time during which the user stays in the car from the boarding floor to the destination floor, which is calculated by the calculation unit 11c.

In step S12, the calculation unit 11c calculates the user's in-car stay time when a car is allocated on the basis of the evaluation value calculated in step S11 and a call registration for a new hall destination call is made, and then advances the processing to step S13.

Specifically, the calculation unit 11c calculates the prediction value of the user's in-car stay time, assuming that the car with the highest evaluation value is allocated to the new hall destination call and its call registration is made. This calculation is performed referring to the call registration information file 40, taking into account the number of stops and the stopping floors along the way, calculating the time required for the car to move from the moving speed of the car in its movement path, and adding the stay time at each stopping floor to the calculated time. This is because, in moving the car of the elevator unit 100, an acceleration operation, a maximum speed operation, and a deceleration operation are performed from the start of movement to the stop of the car, and thus the total in-car stay time varies depending not only on the number of stops along the way but also on the car stopping floors along the way.

Note that this calculation may be performed by simulating the car movement every time a new hall destination call is made, or by storing prediction values based on the distance between the floors as well as the car stopping floors along the way in advance in the memory unit 12 and referring to the values. In the present disclosure, calculation includes reference to such values stored in advance in the memory unit 12.

In addition, other factors may be taken into account in calculating the in-car stay time; for example, on a floor where many people get in and out of the car, the in-car stay time may be added to account for the time it takes to get in and out of the car.

In step S13, the selection unit 11d determines whether or not there is a past hall destination call in the call registration information file 40 that is similar to the new hall destination call with the allowable-number-of-passengers information 40e of one or more passengers, and if there is, advances the processing to step S14, and if not, advances the processing to step S15.

The past hall destination call that is similar to the new hall destination call is a past hall destination call whose boarding floor information 40b and destination floor information 40c are floors within their respective predetermined ranges. In the present embodiment, “within the predetermined ranges” means within ranges in which the boarding floor is the same as the new hall destination floor and the destination floor is within one floor above or below the new hall destination floor. Therefore, the selection unit 11d determines whether or not there is, in the call registration information file 40, a past hall destination call whose boarding floor information 40b, destination floor information 40c, and allowable-number-of-passengers information 40e meet the respective conditions. In addition, the selection unit 11d extracts a past hall destination call that meets the conditions, and temporarily stores its registration number information 40a in the memory unit 12.

In step S14, the selection unit 11d determines, from among the past hall destination calls temporarily stored in step S13, whether or not there is a hall destination call whose in-car stay time information 40f is shorter than the in-car stay time of the new hall destination call calculated in step S12, and if there is, advances the processing to step S17, and if not, advances the processing to step S15. Specifically, by referring to the registration number information 40a stored in the memory unit 12 in step S13, the target past hall destination call is extracted from the call registration information file 40, and its in-car stay time information 40f is compared with the in-car stay time of the new hall destination call.

In step S15, the registration unit 11b makes call registration of the new hall destination call and advances the processing to step S16. Specifically, the registration unit 11b newly adds one piece of registration number information 40a, and stores, in association with the added registration number information 40a, the information indicating the floor where the hall operation indicator 20 is set and the information on the floor corresponding to the operation button 24, which are included in the call information on the new hall destination call, in the boarding floor information 40b and the destination floor information 40c, respectively. Further, the registration unit 11b determines the car with the highest evaluation value calculated in step S11 as the allocated car, and stores it in the allocated car information 40d. The registration unit 11b also calculates the allowable number of passengers on the basis of the difference between the rated load capacity of the allocated car and the total load capacity calculated from other past hall destination calls, and stores the calculated allowable number of passengers in the allowable-number-of-passengers information 40e. Then, the in-car stay time calculated by the calculation unit 11c in step S12 is stored in the in-car stay time information 40f.

At this time, since the new hall destination call is newly added to the call registration information file 40 as a past hall destination call, the calculation unit 11c updates the in-car stay time information 40f of the past hall destination call, among the past hall destination calls stored in the call registration information file 40, for which a stop along the way has newly occurred. Specifically, the calculation is performed in the same manner as that for the new hall destination call in step S12, and the update is made.

In step S16, the control unit 11a outputs a signal to cause the display unit 23 of the hall operation indicator 20 to display information on the car allocated to the new hall destination call and the destination floor corresponding to the operation button 24 representing the destination floor inputted by the user. Specifically, information for displaying the destination floor information and the allocated car information that correspond to the destination floor information 40c and the allocated car information 40d, respectively, stored in the call registration information file 40 in step S15, is outputted.

On the other hand, in step S17, the selection unit 11d selects the past hall destination call with the shortest in-car stay time as the alternative candidate for call registration of the new hall destination call and advances the processing to step S18. Specifically, from among the past hall destination calls that meet the conditions and temporarily stored in the memory unit 12 in step S13, the one with the lowest value of the in-car stay time information 40f is selected as the alternative candidate, and its registration number information 40a is stored in the memory unit 12. In other words, even if a past hall destination call is allocated to a different car than the car allocated to the new hall destination call in step S12, the past hall destination call will be selected as the alternative candidate if its in-car stay time information 40f has the lowest value.

In step S18, instead of call registration for the new hall destination call in step S15, the registration unit 11b reduces, by one, the allowable-number-of-passengers information 40e of the car allocated to the past hall destination call selected as the alternative candidate in step S17. Specifically, by referring to the registration number information 40a of the alternative candidate stored in the memory unit 12 in step S17, the allocated car information 40d corresponding to the registration number information 40a are identified in the call registration information file 40. Then, the allowable-number-of-passengers information 40e of the past hall destination call that has the same allocated car information 40d is reduced by one.

In step S19, the control unit 11a outputs a signal to cause the display unit 23 of the hall operation indicator 20 to display information on the allocated car and destination floor of the past hall destination call selected as the alternative candidate in step S17. Specifically, by referring to the registration number information 40a stored in the memory unit 12 in step S17, the allocated car information 40d and the destination floor information 40c that correspond to the registration number information 40a is identified in the call registration information file 40. Then, a signal is outputted to display information on the allocated car and information on the destination floor that correspond to the specified allocated car information 40d and destination floor information 40c, respectively.

The control unit 11a then drives the car while referring to the call registration information file 40. Therefore, when call registration of a new hall destination call is newly made in step S15, the control unit stops the car with the highest evaluation value calculated in step S11 at the hall. On the other hand, when an alternative candidate is selected in step S17, the control unit a stops the car allocated to the past hall destination call that is an alternative candidate, at the user's boarding floor and moves the car to the destination floor of the past hall destination call.

As described above, the present embodiment provides an elevator group control device 10 that can allocate a car with a short in-car stay time to a hall destination call newly made by a user. In addition, by allowing a user who made a new hall destination call to share a car allocated to a past hall destination call whose call registration has already been made, it is possible to maintain transport efficiency of all users.

The inside of the car of the elevator unit 100 is an enclosed space, and depending on the number of passengers on board, it may be a crowded space. According to the present disclosure, by allocating a car with a short in-car stay time to a call made by a user, the user can be provided with floor-to-floor movement with a low risk of infection.

In the present embodiment, when the selection unit 11d selects an alternative candidate, the car allocated to the alternative candidate is automatically allocated to a new hall destination call. Thus, compared to the other embodiments described later, the user can save time and effort in selecting a car.

### Embodiment 2

In step S13 of Embodiment 1, when determining whether or not there is a past hall destination call similar to a new hall destination call, the selection unit 11d used the same predetermined ranges for all users to determine whether or not there is a similar past hall destination call. The present embodiment determines whether or not there is a past hall destination call similar to the new hall destination call using allowable values, which are predetermined ranges set individually by each user. The following description focuses on the differences from Embodiment 1.

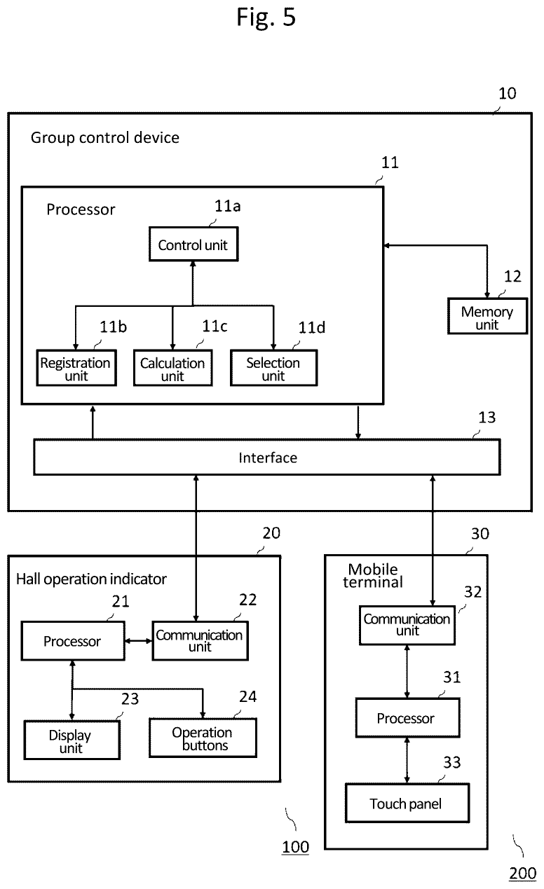

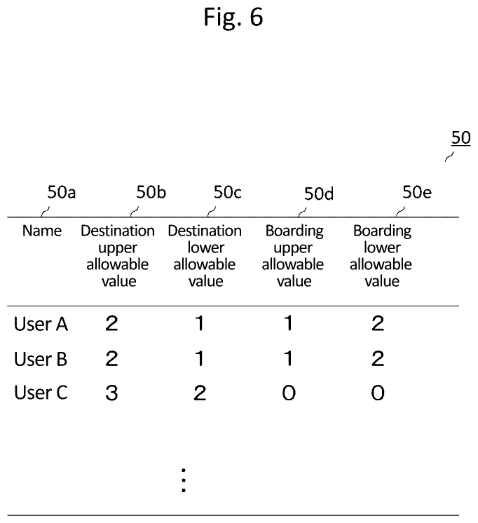

First, the configuration of the present embodiment will be described with reference to FIG. 5 and FIG. 6. In the present embodiment, the elevator unit 100 includes the group control device 10 and the hall operation indicator 20 as in Embodiment 1. Furthermore, the elevator unit 100 communicates with a mobile terminal 30, which is a hall destination calling device carried by a user, to form an elevator system 200.

In the present embodiment, the elevator system 200 includes the mobile terminal 30 in addition to the hall operation indicator 20 as a hall destination calling device; the user can also make a hall destination call by specifying the boarding floor and destination floor from his/her mobile terminal 30.

The mobile terminal 30 includes a processor 31, a communication unit 32, and a touch panel 33. The processor 31 is a CPU that is a control device of the mobile terminal 30, and is connected to the communication unit 32 and the touch panel 33 to exchange information.

The communication unit 32 is a transmitter/receiver that performs wireless communication with the interface 13 of the group control device 10. The touch panel 33 is an operation panel for the user to operate the mobile terminal 30, and is a display for displaying information to the user.

In Embodiment 1, the interface 13 includes a terminal to which an electrical wire is connected. In the present embodiment, the interface 13 includes a transmission/reception device for communicating with the communication unit 32 of the mobile terminal 30, in addition to the components included in Embodiment 1.

In the present embodiment, a user information file 50 shown in FIG. 6 is stored in the memory unit 12. The user information file 50 stores, as an allowable value for each user, how far a floor is allowed to be selected from the user's desired floor when selecting an alternative candidate for a new hall destination call.

The allowable value stored in the user information file 50 can be set separately for each boarding floor and each destination floor. In addition, the allowable value can be set separately for floors above or below the user's desired floor. That is, the user information file 50 has name information 50a for each user and has a destination upper allowable value 50b, destination lower allowable value 50c, boarding upper allowable value 50d, and boarding lower allowable value 50e for each piece of the name information 50a.

In the present embodiment, the control unit 11a includes a software module that updates the user information file 50 on the basis of an input from the mobile terminal 30. The control unit 11a includes a software module that outputs a command to display, on the touch panel 33 of the mobile terminal 30, the boarding floor in addition to the car and the destination floor allocated to the new hall destination call.

Furthermore, the present embodiment of the selection unit 11d includes a software module that refers to the allowable value information stored in the user information file 50, and if the in-car stay time of a past hall destination call within the allowable value is shorter than the in-car stay time of a new hall destination call by the user, the past hall destination call is selected as an alternative candidate for the new hall destination call.

For example, FIG. 6 shows that Mr. A can allow a range from two floors above to one floor below the desired floor for destination floors, and one floor above to two floors below the desired floor for boarding floors.

The user can predetermine the range of alternative candidates to be selected when making his/her hall destination call by sending the allowable value information to the group control device 10 using the mobile terminal 30 in advance and updating the user information file 50.

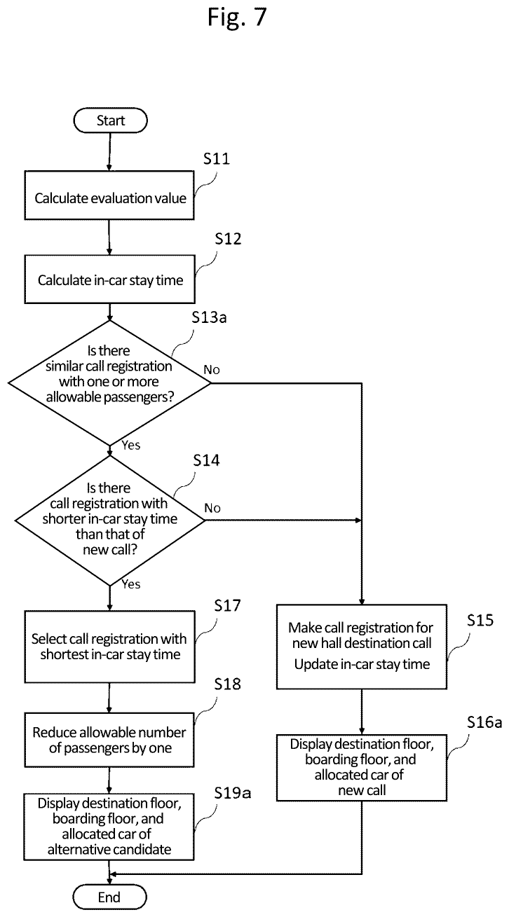

Next, the operation of the present embodiment will be described using FIG. 7. FIG. 7 is a flowchart showing the control when the user makes a new hall destination call using the mobile terminal 30. When a user makes a new hall destination call using the hall operation indicator 20, the same control as that in Embodiment 1 is performed.

In Embodiment 1, the control unit 11a starts the processing when receiving the call information transmitted from the hall operation indicator 20. In the present embodiment, the processing is also started when the user transmits the call information using the mobile terminal 30. The call information transmitted from the mobile terminal 30 includes name information that is information for identifying the user and information on the boarding floor and destination floor desired by the user.

In step S13a, in Embodiment 1, the same predetermined range is used for all users to determine whether there are similar past hall destination calls. In the present embodiment, in step S13, the selection unit 11d refers to the user information file 50 to determine whether or not there is a past hall destination call within a range predetermined by the user who made the new hall destination call.

Specifically, the selection unit 11d uses the name information included in the call information to search for the name information 50a in the user information file 50 and temporarily stores the allowable value information in the memory unit 12. Then, the selection unit 11d determines whether or not there is a past hall destination call in the call registration information file 40 whose boarding floor information 40b, destination floor information 40c, and allowable-number-of-passengers information 40e meet their respective conditions. At this time, the conditions for the boarding floor information 40b and the destination floor information 40c are that the boarding floor and destination floor information included in the call information on the new hall destination call must be within their respective ranges of the allowable values. The condition of the allowable-number-of-passengers information 40e is that there is one or more passengers as in Embodiment 1. Then, as in Embodiment 1, a past hall destination call that meets the conditions is extracted, and its registration number information 40a is temporarily stored in the memory unit 12.

In step S16a and step S19a, the control unit 11a outputs a command to the mobile terminal 30 to display information on the destination floor, the boarding floor, and the allocated car.

As described above, according to the present embodiment, the selection range of the alternative candidates can be set for each user. This allows users to use the elevator unit 100 more comfortably by considering the risk of infection and the load of using stairs to move between floors and setting in advance ranges of alternative candidates that are suitable for them.

### Embodiment 3

In Embodiments 1 and 2, the group control device 10 selects an alternative candidate for a new hall destination call on the basis of only the in-car stay time, and automatically allocates a car to the call. The present embodiment uses a plurality of criteria to select alternative candidates, which is performed by the selection unit 11d of the group control device 10, and after the selection of the plurality of alternative candidates, the options are presented to the user. The following description focuses on the differences from Embodiment 2. First, the configuration of the present embodiment will be described.

In Embodiment 2, the calculation unit 11c includes the software module for calculating the evaluation value and the in-car stay time. In the present embodiment, the calculation unit 11c further includes a software module that calculates an amount of congestion in a car, a risk index indicating a level of risk of infection, a hall waiting time until the car arrives at the hall, and the total waiting time, which is the sum of the hall waiting time and in-car stay time and is the time it takes for a user to arrive at a destination floor.

The amount of congestion is an amount indicating a population density in the car. In the present embodiment, because the floor area of each car in the elevator unit 100 is the same, the amount of congestion is equal to the ratio of the number of passengers on board. The risk index is an index calculated on the basis of the amount of congestion and the in-car stay time, and is calculated by the product of the amount of congestion and the in-car stay time in the present embodiment.

In Embodiment 2, the selection unit 11d selects a past hall destination call with a short in-car stay time as an alternative candidate for a new hall destination call. In the present embodiment, the selection unit 11d selects a past hall destination call that satisfies a predetermined option criterion. Specifically, the selection unit 11d includes a software module that selects, as an alternative candidate, a past hall destination call with a low risk index and a past hall destination call with a short total waiting time in addition to a car with a short in-car stay time.

In Embodiment 2, the control unit 11a outputs a command to cause the display unit 23 to display a car and a destination floor allocated to a new hall destination call. In the present embodiment, the control unit 11a includes a software module that causes the mobile terminal 30, which is a hall destination calling device, to display destination floors and in-car stay times for the call registration options including alternative candidates selected by the selection unit 11d.

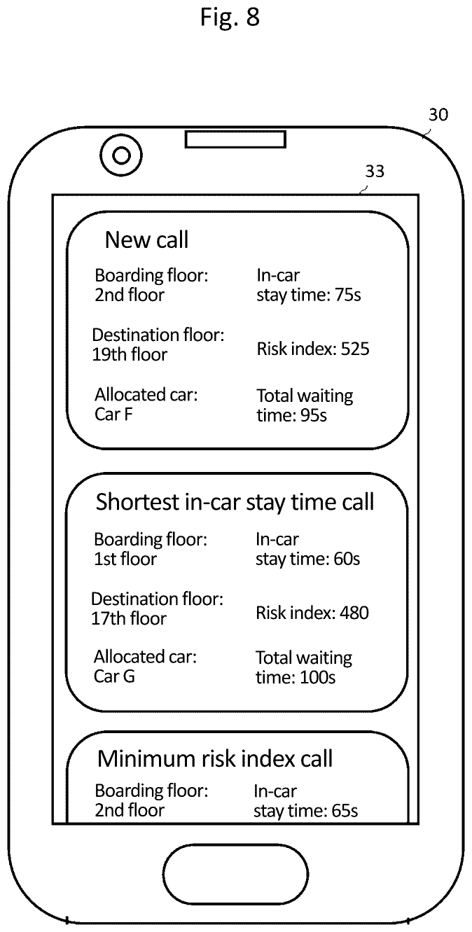

Specifically, the software module outputs a command to display a boarding floor, a destination floor, an allocated car, an in-car stay time, a risk index, and a total waiting time for each of the past hall destination call with the shortest in-car stay time, the past hall destination call with the lowest risk index, and the past hall destination call with the shortest total waiting time, which are selected by the selection unit 11d, and the new hall destination call. FIG. 8 is a diagram showing the mobile terminal 30 in which options are displayed on the touch panel 33.

In Embodiment 2, when a user makes a hall destination call, the registration unit 11b makes a call registration, in the call registration information file 40, for a destination floor, a boarding floor, and an allocated car that are automatically determined. In the present embodiment, the registration unit 11b includes a software module that makes a call registration in the call registration information file 40 on the basis of an option selected by the user.

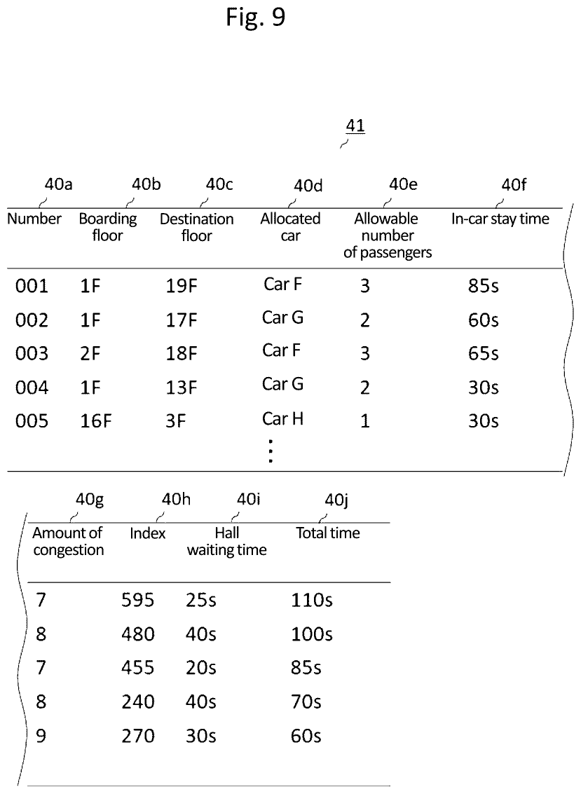

In the present embodiment, the memory unit 12 includes a call registration information file 41 shown in FIG. 9 instead of the call registration information file 40. The call registration information file 41 includes amount-of-congestion information 40g, index information 40h, hall waiting time information 40i, and total time information 40j, in addition to the registration number information 40a, the boarding floor information 40b, the destination floor information 40c, the allocated car information 40d, the allowable-number-of-passengers information 40e, and the in-car stay time information 40f. The amount-of-congestion information 40g, the index information 40h, the hall waiting time information 40i, and the total time information 40j are information showing the amount of congestion, the risk index, the hall waiting time, and the total waiting time calculated by the calculation unit 11c, respectively. The total waiting time is the sum of the in-car stay time and the hall waiting time.

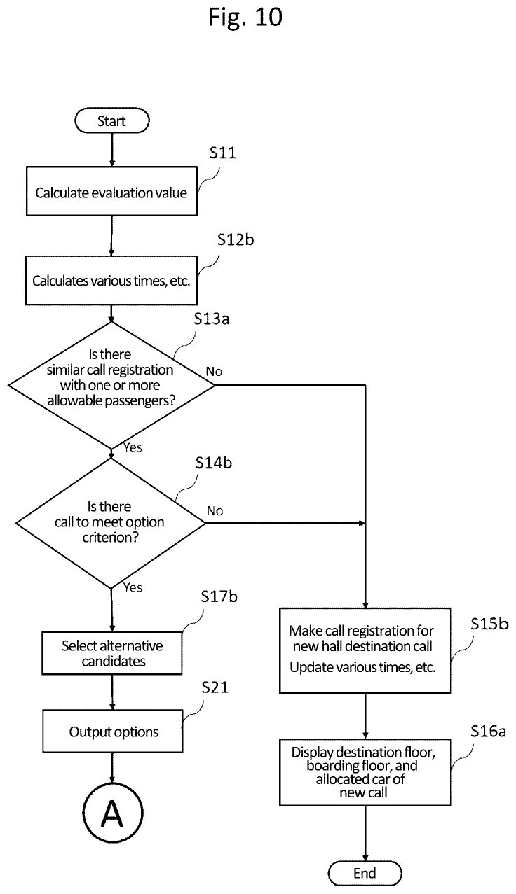

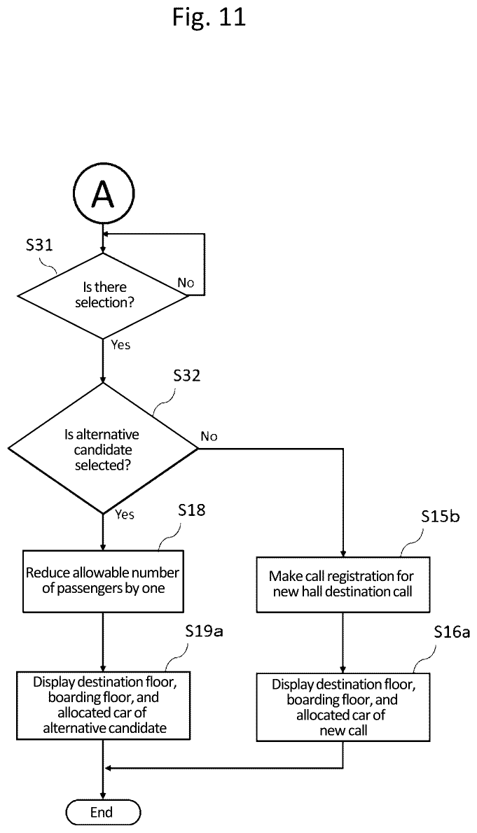

Next, an operation of the present embodiment will be explained using FIG. 10 and FIG. 11. FIG. 10 is a flowchart showing the control for outputting call registration options. The terminal A in FIG. 10 is the same as the terminal A in FIG. 11. These terminals A indicate that the processing of step S31 is performed after step S21 in FIG. 10.

Similar to the processing of Embodiment 2 described in FIG. 7, this control is started when a hall destination call is made from the mobile terminal 30. When a hall destination call is made from the hall operation indicator 20, call registration is performed by the same control as that in Embodiment 1.

In step S12b, the calculation unit 11c calculates various times and the like. Specifically, the calculation unit 11c calculates the in-car stay time, the amount of congestion, the risk index, the hall waiting time, and the total waiting time on the assumption that the car with the highest evaluation value calculated in step S11 is allocated to a new hall destination call and its call registration is made.

In the calculation in step S12b, the calculation unit 11c calculates the user, various times, and the like as in step S12 of Embodiment 2 assuming that the car with the highest evaluation value is allocated to the new hall destination call and its call registration is made. This calculation is performed by the calculation unit 11c, which obviously refers to the call registration information file 41 and takes into account the number of stops along the way and other factors.

In step S14b, the selection unit 11d determines whether or not there is a past hall destination call that meets a predetermined option criterion among the past hall destination calls temporarily stored in step S13a, and if there is, advances the processing to step S17b, and if not, advances the processing to step S15b. As in step S14 of Embodiment 2, the selection unit 11d extracts a target past hall destination call from the call registration information file 40 by referring to the registration number information 40a stored in the memory unit 12 in step S13a, and determines whether or not a predetermined option criterion is met.

In the present embodiment, there are three predetermined option criteria as follows. The first is that the in-car stay time information 40f is shorter than the in-car stay time of the new hall destination call calculated in step S12b. The second is that the index information 40h is smaller than the risk index of the new hall destination call calculated in step S12b. The third is that the total time information 40j is shorter than the total waiting time for the new hall destination call calculated in step S12b.

In step S15b, the registration unit 11b makes a call registration for the new hall destination call and advances the processing to step S16a. Specifically, in step S15b, the registration unit 11b stores the amount-of-congestion information 40g, the index information 40h, the hall waiting time information 40i, and the total time information 40j in the call registration information file 41, in addition to the processing similar to that in step S15 of Embodiment 2.

At this time, the calculation unit 11c also updates the in-car stay time information 40f, the amount-of-congestion information 40g, the index information 40h, the hall waiting time information 40i, and the total time information 40j for the past hall destination call for which a new stop along the way occurred among the past hall destination calls stored in the call registration information file 41.

In step S17b, the selection unit 11d selects alternative candidates for the new hall destination call and advances the processing to step S21. Specifically, the selection unit 11d selects the call with the shortest in-car stay time, the call with the lowest risk index, and the call with the shortest total waiting time from among the past hall destination calls temporarily stored in the memory unit 12 in step S13a, and temporarily stores them in the memory unit 12 as the alternative candidates.

In step S21, the control unit 11a outputs a command to cause the mobile terminal 30 to display call registration options and advances the processing to step S31. The call registration options are the new hall destination call and the past hall destination calls selected as the alternative candidates by the selection unit 11d in step S17b. Specifically, for the new hall destination call, the control unit 11a outputs a command to cause the mobile terminal 30 to display the following: the information on the boarding floor and hall destination floor desired by the user included in the call information sent by the user from the mobile terminal 30, the car with the highest evaluation value calculated by the calculation unit 11c in step S11, and the in-car stay time, risk index, and total waiting time which are calculated by the calculation unit 11c in step S12b. In addition, for the alternative candidates, the control unit 11a outputs a command to cause the mobile terminal 30 to display the boarding floor information 40b, the destination floor information 40c, the allocated car information 40d, the in-car stay time information 40f, the index information 40h, and the total time information 40j.

In step S31 shown in FIG. 11, the control unit 11a waits for the information on the option selected by the user to be transmitted from the mobile terminal 30. The control unit 11a advances the processing to step S32 when receiving the information on the option selected by the user via the interface 13.

In step S32, the control unit 11a determines whether or not the option selected by the user is an alternative candidate, and if it is, advances the processing to step S18, while if the option selected by the user is the new hall destination call, advances the processing to step S15b.

As described above, the present embodiment provides a group control device 10 that can allocate a car with a short in-car stay time to a hall destination call in the same way as in Embodiments 1 and 2. Furthermore, according to the present embodiment, if the user wishes to select another car on the basis of another criterion, the user can select a past hall destination call selected as an alternative candidate on the basis of said another criterion. Also, even when an alternative candidate is selected on the basis of a criterion other than the in-car stay time, the transportation efficiency of all users can be maintained because it is selected from the past hall destination calls as in Embodiment 1 and Embodiment 2.

### Embodiment 4

In step S14b of Embodiment 3, when determining whether or not there is a past hall destination call that satisfies an option criterion, the selection unit 11d determines whether or not there is a past hall destination call that satisfies the option criterion by using the same option criterion for all users. The following description focuses on the differences from Embodiment 3. First, the configuration of the present embodiment will be described.

The memory unit 12 of the present embodiment stores a user information file 51 instead of the user information file 50 of Embodiment 3. In addition to the allowable value information stored in the user information file 50, the user information file 51 includes option criterion information 50f for each piece of the name information 50a.

The option criterion information is set by a user using the mobile terminal 30. In addition to the option criteria used in step S14b of Embodiment 3, an option criterion may be, for example, “a past hall destination call whose in-car stay time is at least 10 seconds shorter than that of the new hall destination call”.

In the present embodiment, control unit 11a further includes a software module that updates the user information file 51 on the basis of input from the mobile terminal 30. The selection unit 11d also includes a software module that determines the option to be displayed on the mobile terminal 30 on the basis of the option criterion selected by the user.

Next, the operation of the present embodiment will be described.

In the present embodiment, in step S14b, the selection unit 11d refers to the user information file 51 to determine whether or not there is a past hall destination call that meets a predetermined option criterion among the past hall destination calls temporarily stored in step S13a. Specifically, the selection unit 11d searches for the name information 50a in the user information file 51 using the name information included in the call information as in step S13a, and temporarily stores the corresponding option criterion information 50f in the memory unit 12. The selection unit 11d then determines whether or not there is a past hall destination call in the call registration information file 41 that meets the option criterion.

Further, in step S17b of the present embodiment, the selection unit 11d selects a past hall destination call that meets the option criterion set by the user as an alternative candidate and temporarily stores it in the memory unit 12.

As described above, the present embodiment provides a group control device 10 that can allocate a car with a short in-car stay time to a hall destination call as in Embodiment 3. Furthermore, the present embodiment has the advantage that the user can set an option criterion, which makes it easier for the user to select a call registration option.

The embodiments are described above; however, the present invention is not limited to the embodiments. Modifications will be described below.

In the embodiments, the selection unit 11d compares the in-car stay time of a new hall destination call with the in-car stay time information 40f stored in the call registration information files 40 and 41; however, without storing the in-car stay time information 40f in the call registration information files 40 and 41, the calculation unit 11c may also make calculations for the past hall destination calls when the new hall destination call is received. The same applies to the amount-of-congestion information 40g and the total time information 40j.

In Embodiments 2 to 4, when a hall destination call is made from the hall operation indicator 20, the group control device 10 makes call registration by the same processing as that in Embodiment 1. However, if the hall operation indicator 20 includes a component to identify a user, the selection unit 11d may select an alternative candidate on the basis of the allowable value for each user, as in the case where a hall destination call is made from the mobile terminal 30 in Embodiments 2 to 4. The component to identify a user is, for example, a card reader.

If the hall operation indicator 20 is equipped with a component that displays options and accepts the user's selection of an option, the options may be output to the hall operation indicator 20 in the same way as when a hall destination call is made from the mobile terminal 30 in Embodiment 3 or 4. A component that displays options and accepts both companies' selection of an option is, for example, a touch panel.

In the embodiments, the selection unit 11d refers to the allowable-number-of-passengers information 40e to determine whether or not there is a similar past hall destination call with one or more allowable-number-of-passengers. However, in this determination, it may be determined whether or not there are similar past hall destination calls equal to or more than another number of passengers. For example, a past hall destination call for which the allowable number of passengers for the allocated car is equal to or less than a predetermined number (for example, five) may not be included in the options. By giving a margin to the allowable number of passengers in this way, it is possible to prevent a situation in which, while a user is selecting an option, another user makes a hall destination call and the number of passengers exceeds the allowable number of passengers, so that the user cannot share a ride.

### REFERENCE SIGNS LIST

10 group control device
11 processor
11a control unit
11b registration unit
11c calculation unit
11d selection unit
12 memory unit
13 interface
20 hall operation indicator
21 processor
22 communication unit
23 display unit
24 operation buttons
30 mobile terminal
31 processor
32 communication unit
33 touch panel
40, 41 call registration information file
40a registration number information
40b boarding floor information
40c destination floor information
40d allocated car information
40e allowable-number-of-passengers information
40f in-car stay time information
40g amount-of-congestion information
40h index information
40i hall waiting time information
40j total time information
50, 51 user information file
50a name information
50b destination upper allowable value
50c destination lower allowable value
50d boarding upper allowable value
50e boarding lower allowable value
50f option criterion information
100 elevator unit
200 elevator system

1. An elevator group control device comprising:
a processor to perform processes according to software modules; and
a memory to store data used by the processor to perform the processes,
the processes including:
making call registration for a boarding floor, a destination floor, and an allocated car when a user makes a hall destination call by a hall destination calling device;
calculating an in-car stay time of the user for the hall destination call; and
selecting a past hall destination call as an alternative candidate for call registration for a new hall destination call which is a hall destination call newly made by the user, in a case where the past hall destination call is a hall destination call which has already been registered, whose allocated car is different from a car allocated to the new hall destination call, and whose in-car stay time is shorter than the calculated in-car stay time.

2. The elevator group control device according to claim 1, wherein
the elevator group control device selects the alternative candidate from past hall destination calls whose registered destination floors are within a predetermined range from the destination floor of the new hall destination call, and whose registered boarding floors are within a predetermined range from the boarding floor of the new hall destination call.

3. The elevator group control device according to claim 2, wherein
the predetermined ranges used by the elevator group control device to select the alternative candidate are set by the user.

4. The elevator group control device according to claim 1, wherein
the elevator group control device selects a past hall destination call with a shortest in-car stay time as the alternative candidate.

5. The elevator group control device according to claim 1, wherein
the processes further include outputting a command to the hall destination calling device to display information on the destination floor of the past hall destination call that is the alternative candidate and the allocated car when the elevator group control device selects the alternative candidate, and outputting a command to the hall destination calling device to display the car allocated to the new hall destination call and the destination floor inputted by the user when the elevator group control device selects no alternative candidate.

6. The elevator group control device according to claim 5, wherein
when the alternative candidate is selected, the elevator group control device stops the car allocated to the past hall destination call that is the alternative candidate at the user's boarding floor.

7. The elevator group control device according to claim 1, wherein
the processes further include outputting a command to cause the hall destination calling device to display a plurality of options including the new hall destination call and the alternative candidate together with the destination floor and the in-car stay time for each of the plurality of options.

8. The elevator group control device according to claim 7, wherein
the elevator group control device does not include in the plurality of options a past hall destination call whose allowable number of passengers in its allocated car is less than or equal to a predetermined number of passengers.

9. The elevator group control device according to claim 7, wherein
the elevator group control device determines the plurality of options to be displayed on the hall destination calling device on a basis of option criteria set by the user.

10. The elevator group control device according to claim 7, wherein
the elevator group control device outputs a command to cause the hall destination calling device to display an index calculated on a basis of an amount of congestion of the car and the in-car stay time for each of the plurality of options.
